(19) United States
(12) Patent Application Publication
(10) Pub. No.: US 2024/0349932 A1
(43) Pub. Date: Oct. 24, 2024

(54) BEVERAGE FILTER PRESS, CARAFE AND ORGANIZER HOLDER

(71) Applicant: AeroPress, Inc., Palo Alto, CA (US)

(72) Inventors: Matthew Brown, Raleigh, NC (US); Dale Woiken, Upland, CA (US); Edmund Lee, Encino, CA (US)

(73) Assignee: AeroPress, Inc., Palo Alto, CA (US)

(21) Appl. No.: 18/642,556

(22) Filed: Apr. 22, 2024

Related U.S. Application Data
(60) Provisional application No. 63/497,505, filed on Apr. 21, 2023.

(51) Int. Cl. A47J 31/36; A47J 31/08

(52) U.S. Cl. CPC A47J 31/36; A47J 31/08

(57) ABSTRACT

A beverage filtering press, preferably for pressing coffee beverages, includes a hollow cylinder, a removable filter cap, a removable piston that is inserted in the cylinder and pressed downward to force beverage through the filter cap, and a support to hold the press above the mouth of an open vessel. Oversized filtering presses for dispensing multiple serving of beverage are provided. Beverage presses are provided that include a hollow cylinder and piston both formed of plastic, including a clear plastic. Alternatively, beverage presses are provided that include a cylinder formed of glass and a piston formed of metal, such as stainless steel or aluminum. The support and filter cap can also be formed of plastic or a metal, such as stainless steel or aluminum. A carafe specially shaped to correspond to the support can be used. Organizer holder stands that accommodate various beverage presses are also provided.

### CROSS REFERENCES TO RELATED APPLICATION

This application is a Non-Provisional of and claims the benefit of priority to U.S. Provisional Application No. 63/497,505 filed Apr. 21, 2023, the entire contents of which are incorporated herein by reference.

### FIELD OF THE INVENTION

The present invention relates generally to beverage makers and more specifically to beverage presses for making coffee or tea, and associated carafes and organizer stands.

### BRIEF SUMMARY

According to an aspect of the present invention, a beverage filtering press, typically for filtering coffee beverages, includes a hollow cylinder having top and bottom openings, a removable filter cap which encloses the bottom opening, a removable piston which is inserted into the top opening and pressed downward to force liquid in the cylinder through the perforated cap, and a support to hold said press above the mouth of an open vessel. The support may extend radially outward from the hollow cylinder, or it may extend radially outward from the filter cap.

In a first aspect, the invention pertains to an oversized beverage press dimensioned with an increased capacity (e.g. 500 ml, 590 ml, 600 ml or more) to dispense multiple beverages. The oversized beverage press can further be configured for use with a specially shaped carafe having vertically oriented sides and a flat top specially shaped to accommodate the support of the oversized press. In a second aspect, the invention pertains to beverage presses that include clear components (e.g. clear cylinder and clear piston body), or a clear glass cylinder with metal base and a metal piston, support and cap for improved durability and aesthetics. In a third aspect, the invention pertains to an organizer holder having a frame or ring with an opening that supports both the piston and cylinder side-by-side and a vertical support, which optionally can be adjusted or replaced to accommodate both standard and oversized beverage presses. The stand can further include accessory holders or cups and filter paper and beverage cap holders.

A further understanding of the nature and advantages of the present invention may be realized by reference to the remaining portions of the specification and the drawings.

### BRIEF DESCRIPTION OF THE DRAWINGS

FIGS. 1A-1D illustrate an oversized beverage press for pressing multiple beverage servings, such as twice that of conventional presses, in accordance with some embodiments.

FIG. 2A-2C illustrate the oversized beverage press atop a beverage carafe specially configured for use with the oversize beverage press, in accordance with some embodiments.

FIG. 3 illustrates the beverage carafe specially configured for use with the oversize beverage press, in accordance with some embodiments.

FIG. 4A-4D illustrate a premium beverage press having a metal piston and clear outer cylinder, in accordance with some embodiments.

FIG. 5A-5D illustrate another premium beverage press having a metal piston and clear outer cylinder, in accordance with some embodiments.

FIG. 5E-5F illustrate details of the metal base mounted on the glass cylinder of the premium beverage press of FIG. 5A, in accordance with some embodiments.

FIG. 5G-5H illustrate exploded views of the cylinder and piston, respectively, of the premium beverage press of FIG. 5A, in accordance with some embodiments.

FIG. 6A-6C illustrate the double-walled glass cylinder of the premium beverage press of FIG. 5A, in accordance with some embodiments.

FIG. 7A-7D illustrate the piston of the premium beverage press of FIG. 5A, in accordance with some embodiments.

FIGS. 8A and 8B illustrate accessories of the premium beverage press of FIG. 5A, in accordance with some embodiments.

FIG. 9A illustrates a beverage press according to a embodiment of the invention resting on a cup with the mixing paddle deployed during the initial mixing stage;

FIG. 9B illustrates the press with the piston deployed during the pressing stage, in accordance with some embodiments; and

FIG. 9C illustrates an alternative version with the support extending radially outward from the perforated cap, in accordance with some embodiments.

FIGS. 10A-13B illustrates organizer holder stands that can be used to hold and organize components of the various described beverage presses, in accordance with some embodiments.

### DETAILED DESCRIPTION

In one aspect, the invention pertains to an oversized beverage press system for pressing multiple beverage servings, in accordance with some embodiments. Typically, the beverage press is used for pressing coffee beverages. In this embodiment, the beverage press is dimensioned to provide multiple servings of the beverage, each serving being about 240 ml. Preferably, the beverage press is dimensioned with a fluid capacity sufficient to provide at least two servings (e.g. about 480 ml, 500 ml) or more. In some embodiments, the press includes incremental markings on the side of the outer cylinder to allow a user to fill the cylinder to a desired amount. It is noted that the beverage press is not merely a scaled up version of a conventional press with 250 ml capacity, since this may result in a press that is too tall to comfortably and stably operate by most users with the press and cap resting on a counter height, but rather the width dimension has been increased more than the height to readily allow case of operation from a standard kitchen counter height by a wide range of users and reduce likelihood of tipping while pressing.

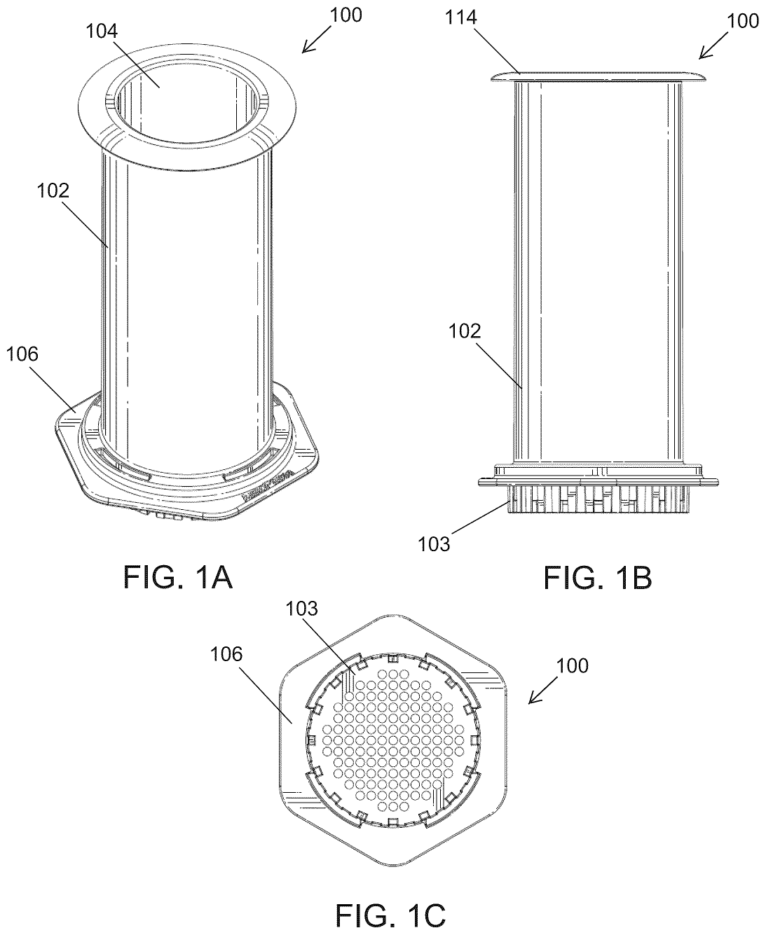

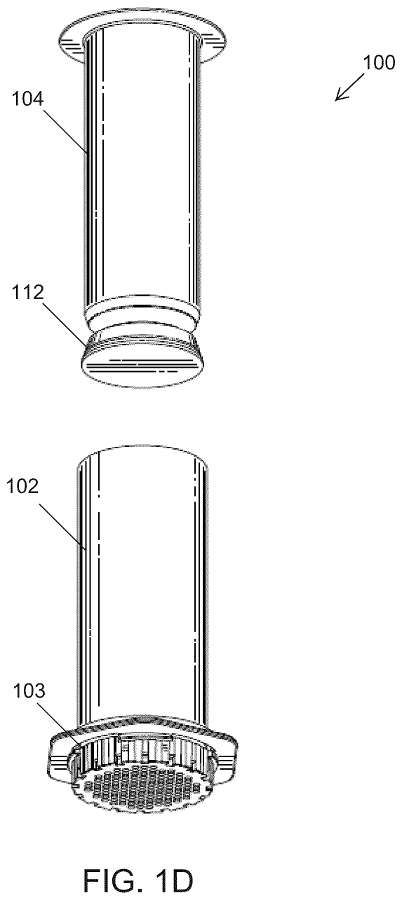

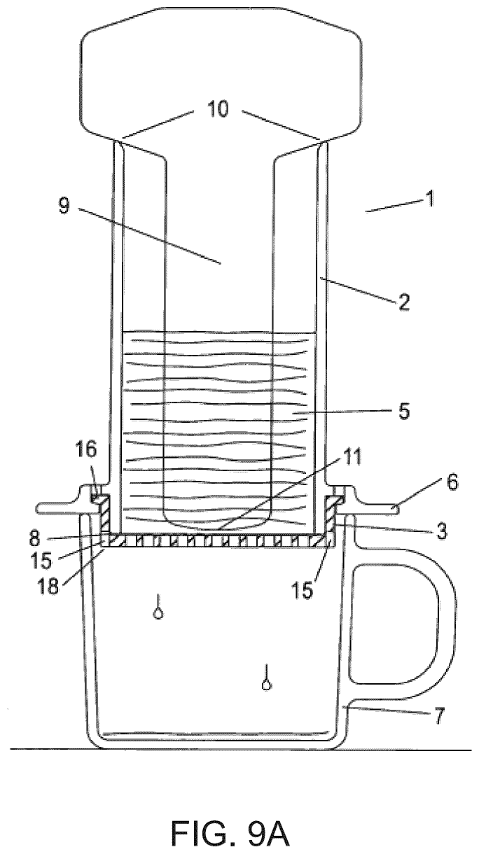

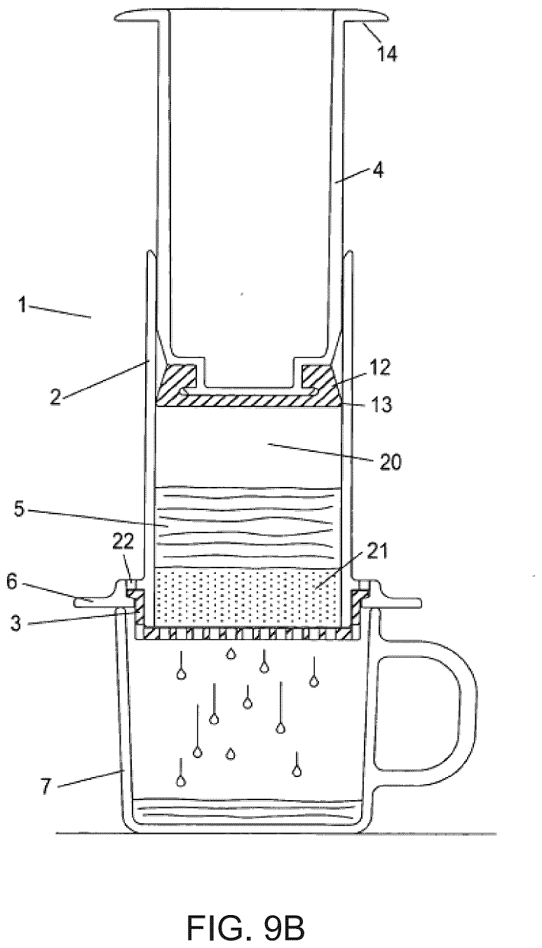

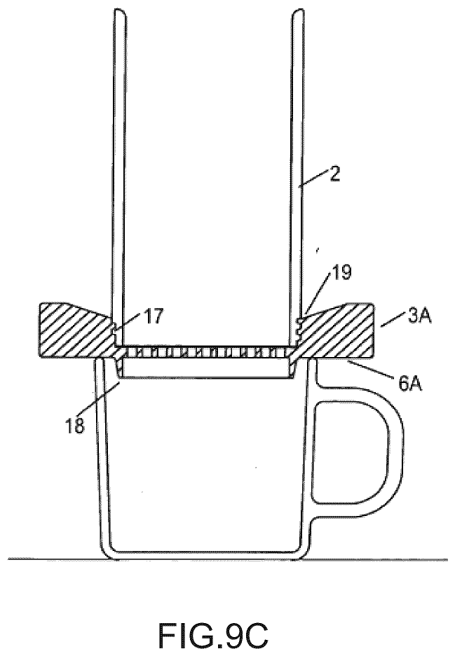

An example of the oversized beverage press dimensioned to provide multiple servings is shown in FIGS. 1A-1D. The oversized press 100 includes same/similar components as the press embodiment shown in FIGS. 9A-9B, and includes corresponding reference numbers for the various components (e.g. cylinder 102 in FIG. 1A corresponding to cylinder 2 in FIG. 9A). The oversized beverage press 100 includes an outer cylinder 102, a filter cap 103 that encloses the bottom opening of the cylinder, and a piston 104 with an air-tight flexible seal 112 at bottom that is inserted within the cylinder to press the beverage through the cylinder and filter cap. The piston includes a stop 114 at top to facilitate manual operation, and the cylinder includes a support 106 extending laterally from near the bottom opening that rests on a vessel (e.g. mug) in which the beverage is dispensed. In some embodiments, the support has a regular polygonal shape. In this embodiment, the support has a hexagonal shape, although it is appreciated the support could be any polygonal shape, or any suitable non-polygonal shape. Exemplary operation of the beverage press can be further understood by referring to FIGS. 9A-9C detailed further below. In some embodiments, the oversized press includes has a cylinder having a total height of 6-10″, typically about 7.25″, while the inside diameter is within a range of about 2-5″, typically about 2.65″. These dimensions provide sufficient capacity (e.g. 500 ml, 590 ml, 600 ml or more) so as to provide multiple dispensed beverages, while providing a more stable, easy to use press assembly. The filter cap 106 can be a cap with multiple perforations for supporting a filter, or can include one or more pressure-activated valve openings for dispensing beverage at higher pressure, such as any of those described in PCT/US2023/086509 filed Dec. 29, 2023, incorporated herein by reference herein.

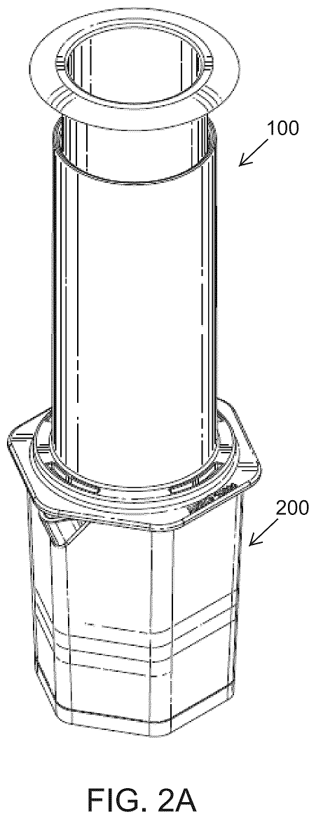

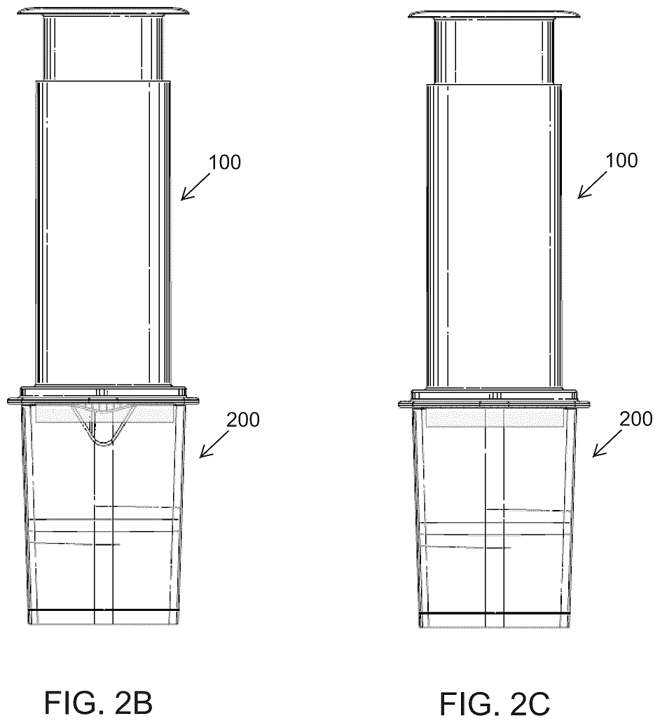

FIG. 2A-2C illustrate the oversized beverage press 100 atop a beverage carafe 200 specially configured for use with the oversize beverage press, in accordance with some embodiments. As used herein, the term “carafe” refers to any vessel storing multiple servings of beverage. As shown, the support of the beverage press and the carafe have corresponding shapes such that the top edge 201 of the carafe firmly engages the bottom side of the support, which provides more stability during pressing, which is particularly helpful when pressing the larger oversized beverage press. In some embodiments, the support and the carafe are both regular polygonal shapes. In this embodiment, both are hexagonal shapes. While certain dimensions are described above, it is appreciated that other embodiments can be configured according to various other dimensions and capacities.

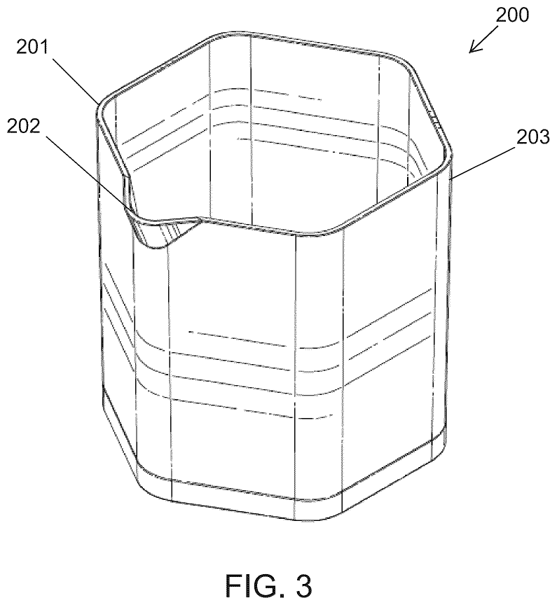

FIG. 3 illustrates a beverage carafe 200 specially configured for use with the oversize beverage press, in accordance with some embodiments. In this embodiment, the carafe has a shape at top that corresponds to the shape of the support, which allows the support to firmly contact the top edge around substantially the entire perimeter of the top opening of the carafe (apart from the spout), thereby providing stability as the piston is being pressed downward to filter the beverage. In this embodiment, the beverage carafe has vertically oriented walls such that the entire carafe is a polygonal prism (e.g. hexagonal prism), which allows the user to readily handle the carafe at any location. The carafe is made from an insulative plastic and of sufficient thickness to insulate the user's hand from heat during handling. The carafe is dimensioned with a capacity to store multiple beverage servings, such as 300-1,000 ml, typically 400-600 ml, preferably at least 500 ml. The carafe can shaped as a polygonal prism with the vertex of the polygon forming rounded corners 203, as shown in FIG. 3. In this embodiment, the sides of the prism extend vertically, which provides more stability during pressing as the top edge 201 corresponds to the bottom perimeter of the press during pressing, thereby reducing likelihood of tipping and spilling during pressing. A depression is formed at one vertex of the top edge of the polygon, which forms a spout 202. In some embodiments, the spout also allows air to be released from the carafe as it is filled with beverage during pressing. Accordingly, the carafe can be shaped so as to correspond to the shape of the support base of the cylinder. In this embodiment, the capacity of the carafe is at least 480 ml, typically about 500 ml, 590 ml, 600 ml or more, which corresponds to at least two beverages dispensed from the oversized press. In some embodiments, the carafe has a height within a range of about 3-5″, typically about 4″ (e.g. 4.288″), while a lateral width (e.g. distance between sides) is within a range of about 4-5″, typically about 4″ (e.g. 3.86″ between parallel sides). In the embodiment of FIG. 3, the carafe is shaped as a regular polygon (e.g. hexagon) and includes a top edge 201 that firmly contacts the underside of the support of the beverage press during use, as described above. The cross-sectional polygonal shape includes multiple vertex 203 that extend vertically as rounded corners 202 which aid the user in handling the carafe. A depression 202 at one vertex forms a spout for pouring the hot beverage. In some embodiments, the carafe has a greatest lateral dimension between 3-5 inches, preferably about 3.8 inches. In some embodiments, the carafe is dimensioned to fit both standard and oversized beverage presses. In some embodiments, the carafe has a height between 4-6 inches, preferably about 4.2 inches. While a polygonal shape (e.g. hexagon) shape is described and depicted, it appreciated that various other shapes (e.g. polygonal, round, etc). could also be used.

In some embodiments, the top opening of the carafe is dimensioned such that the step-down portion of the interior of the press is suitably smaller such that it need not contact the interior walls of the vessel when placed atop the carafe, thereby resulting in a “loose fit” (e.g. with clearance between corresponding edges). In some embodiments, this loose fit entails an extra clearance between interfacing components between 1-10 mm, typically about 2-4 mm. This prevents the press from creating a friction fitted within the vessel during pressing, which can occur in some round presses if engaged with a similar round opening of a standard coffee pot or pitcher typically used for storing multiple beverages. This loose fit is particularly advantageous when used with an oversized beverage press, since were the press friction fitted with the container, may be inadvertently toppled with the beverage press due to increased height. Thus, this loose fit can act as a safety feature to avoid spilling a large quantity of hot beverage, such as coffee, during or after pressing. In some embodiments, the height of the oversized press cylinder is between 4 and 10 inches, such as between 5 and 8 inches, preferably about 6 inches (e.g. 6.5 inches). In some embodiments, the diameter of the oversized press cylinder is between 2 and 5 inches, such as between 2 and 4 inches, preferably about 2.5 inches (e.g. 2.65 inches). The piston is correspondingly sized to engage the interior of the cylinder in an air-tight manner and the filter cap is correspondingly sized to enclose the bottom opening of the cylinder.

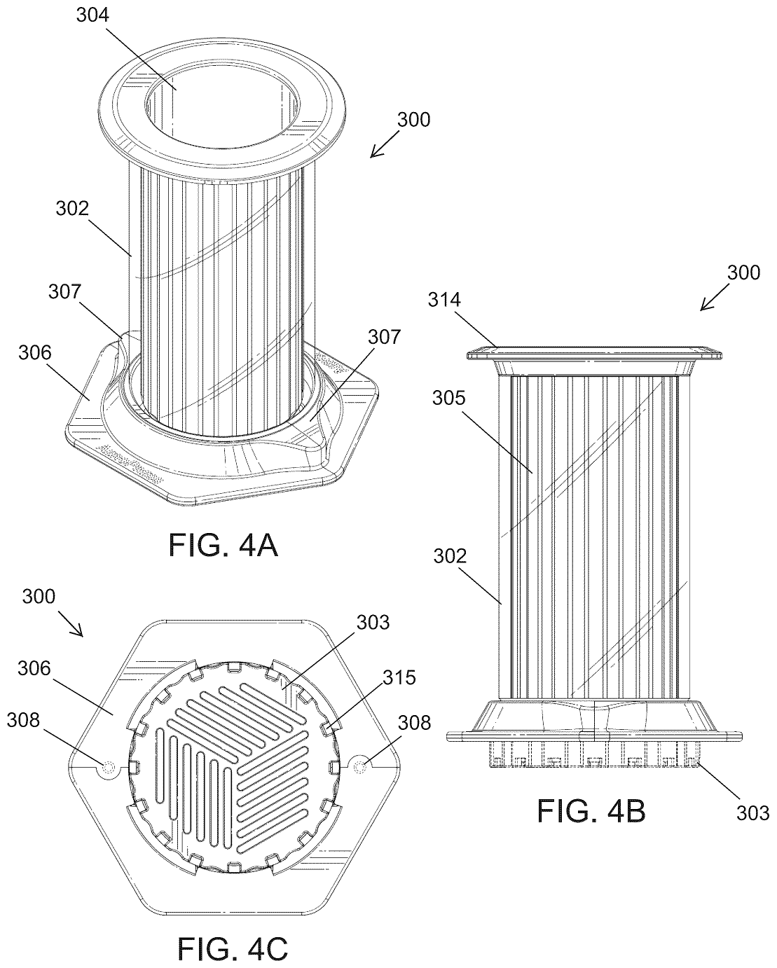

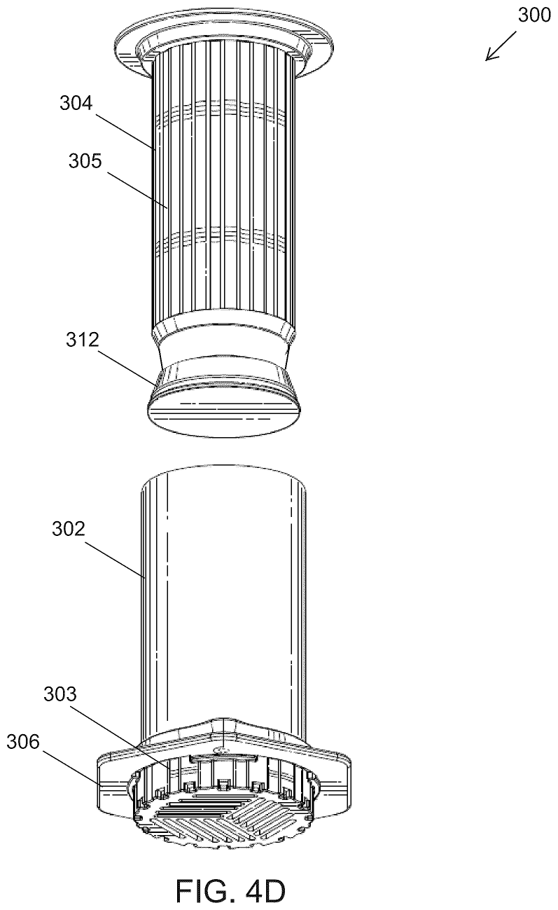

FIG. 4A-4D illustrate a beverage press 300 having a metal piston and clear outer cylinder, typically of glass, in accordance with some embodiments. This construction provides a more premium press having improved durability and aesthetic. This beverage press includes similarly numbered components as the beverage press in FIGS. 1A-ID. The press 300 includes an outer cylinder 302 formed of glass (e.g. borosilicate), and a piston 304 with upper stop 314, the piston main body being formed of a metal, such as aluminum, stainless steel or a metal alloy. In this embodiment, the main body of the piston 304 includes vertical fluting or ridges 205, which increase the compressive strength of the metal wall to better withstand the forces of pressing the piston through the cylinder. The filter cap 303 can also be formed of a metal, such as aluminum or stainless steel. The piston can further include a flexible seal 312 disposed at the bottom end, the flexible seal being made form a flexible elastomeric such as silicone rubber or any suitable material. In this embodiment, the support 306 extends from a larger base that is sealingly coupled around the cylinder near the bottom opening. The cylinder can be sealed with a sealing glue or any suitable means. The base includes raised flared portions 307 that house features that attach the base/support to the cylinder. These features can be accessed by hidden fasteners 308 (e.g. hex head screws) on an underside of the support/base. In this embodiment, the filter cap 303 can include perforated holes in any suitable design (a hatched design shown here) and can include drainage holes 315 can be provided along a periphery. While a particular filter cap is shown, any suitable filter cap can be used. This premium beverage press can be configured with a single beverage capacity (e.g. 250 ml) or with a multi-beverage capacity (e.g. 500 ml, 590 ml, 600 ml, or more).

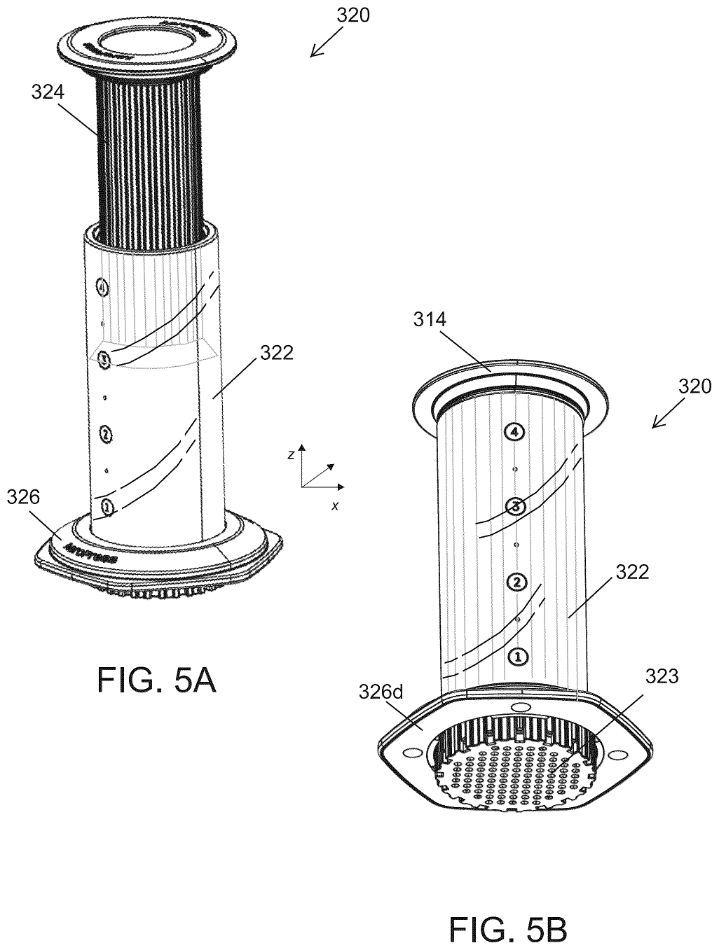

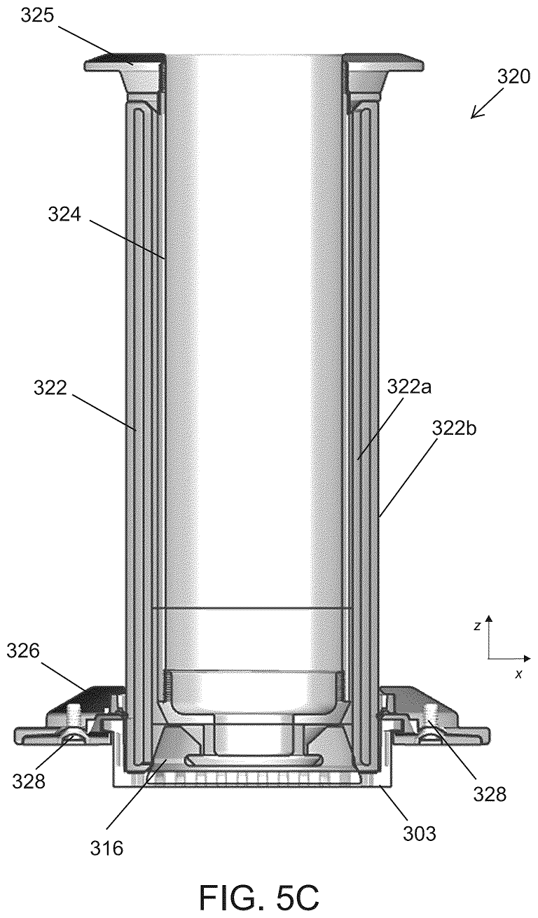

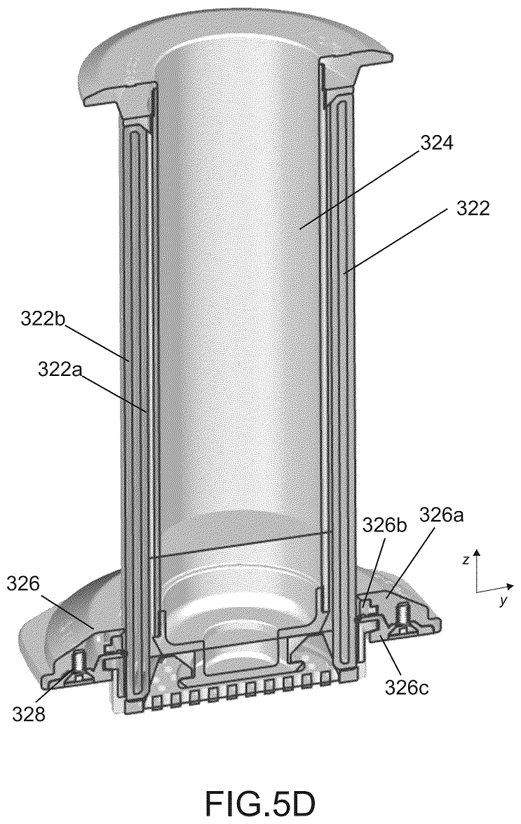

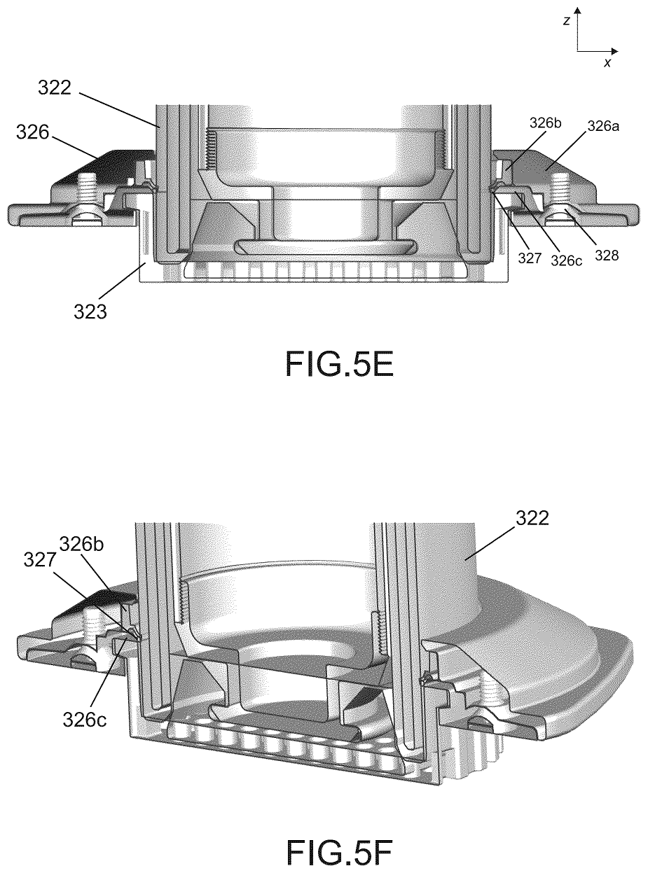

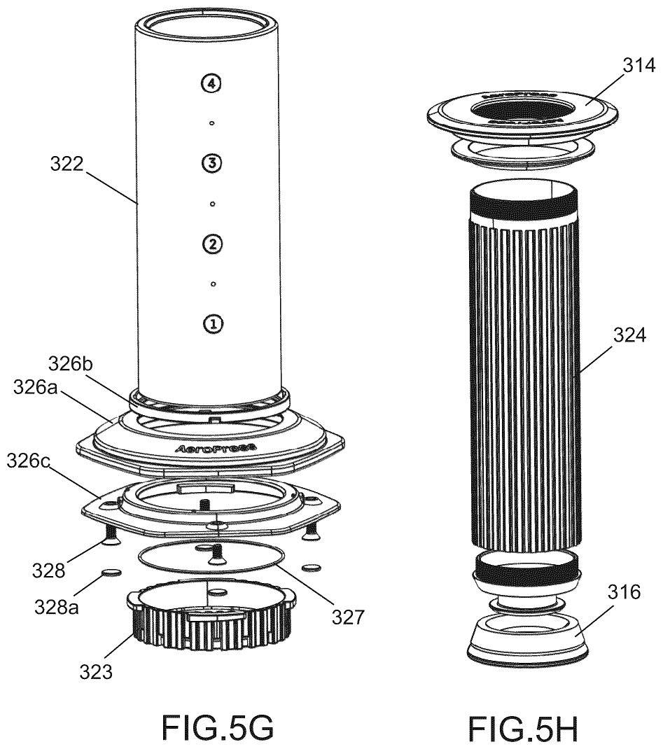

FIGS. 5A-5H show various view of another embodiment of a premium beverage press having a clear glass cylinder and a metal base and piston, in accordance with some embodiments. In this embodiment, the premium beverage press 320 includes a clear double-walled vacuum insulated glass cylinder 322 with a metal support base 326 and a metal piston 324. FIG. 5A shows the metal piston inserted at a mid-point, and FIG. 5B shows the metal piston 324 inserted to its full extension with proximal stop 314 abutted against the top edge of outer cylinder 322. A double-walled glass cylinder is advantageous since single-walled glass does not insulate as well as plastic. In other beverage presses described herein, the outer cylinder is formed of a plastic material, which sufficiently insulates the heated liquid during steeping and pressing such that the user can firmly grasp the cylinder while pressing. Since single-walled glass does not thermally insulate as well as plastic, more heat may be transferred to the glass cylinder, which may cause more heat loss in the fluid during steeping and may cause the cylinder to become uncomfortably hot when held in the user's hand during pressing. Accordingly, a double-walled insulated glass cylinder provides improved insulation, thereby maintaining the heat in the fluid during steeping and preventing the outside of the cylinder from becoming uncomfortably hot during manual grasping of the cylinder during pressing. While there are marked benefits in using a double-walled glass cylinder, construction, and assembly of such a cylinder presents some challenges. The metal support base 326 houses the mounting means to the cylinder and defines the underside surface 326d that engages a top surface of the beverage container receiving the pressed beverage.

In a first aspect, conventional double-walled glass container products do not typically have the size and tolerance constraints associated with a functioning beverage press assembly. To overcome this challenge, the double-walled glass cylinder is formed from two precision dimensioned glass cylinders that are placed concentrically with a precise air-gap between inner and outer walls. The opposite ends at top and bottom openings are joined by seams (e.g. heated glass or curable polymer seams). In some embodiments, the cylinders are joined by a scam at top, after which the bottom ends are joined by another seam, in which one or more holes are left or made. These holes allow air within the air-gap to be withdrawn by a vacuum source, before sealing the one or more holes with a plug, filler or adhesive, to form the vacuum insulated cylinder which improves the thermal insulative properties of the cylinder. This approach allows formation of a double-walled cylinder of a precise dimensions to allow the air-tight piston to maintain the air-type seal along the entire inside diameter of the cylinder during pressing to ensure successful beverage pressing. FIGS. 5C and 5D show sectional views taken along x-z and y-z planes, which show double-walled cylinder 322 includes inner and outer walls 322a, 322b.

In a second aspect, whereas plastic can be injection molded to include additional features, such as the lateral support base, such features cannot readily be incorporated into a double-walled glass cylinder design. While the above approach allows for formation of a precision-dimensioned cylinder, the cylinder must still be attached to a base that can be securely pressed against the beverage container while substantial force is applied during pressing. This can be challenging, given the inherent fragility of glass, since uneven forces can lead to formation of cracks or breaking of the glass over many cycles of use. To address this challenge, a plastic ring is fit tightly on the outside of the glass cylinder near the bottom end and secured by curable adhesive. As shown in FIGS. 5E-5F, the base is then secured against the cylinder with the plastic ring 327 sandwiched between upper and lower mounts (326b, 326c) of the metal base, which are tightened in place with one or more fasteners 328, typically multiple fasteners (e.g. 4 screws) disposed circumferentially about the cylinder. The metal base includes a housing 326a that defines the top surface of the base, partly covers the upper and lower mounts, and defines the outer perimeter of the base. In some embodiments, the lower surface 326d of the support base is defined, at least partly by the lower mount 326c component. This approach distributes mounting forces and the plastic ring 327 more uniformly distributes forces and strains applied during manual pressing. Typically, there are multiple screws distributed about the circumference (e.g. four screw). The fasteners may be applied form a bottom side of the base and covered by one or more plugs 328a. In this embodiment, the components of the base are formed of metal, such as aluminum or stainless steel. The various components of the base and cylinder assembly and the piston assembly can be seen in the exploded views of FIGS. 5G and 5H.

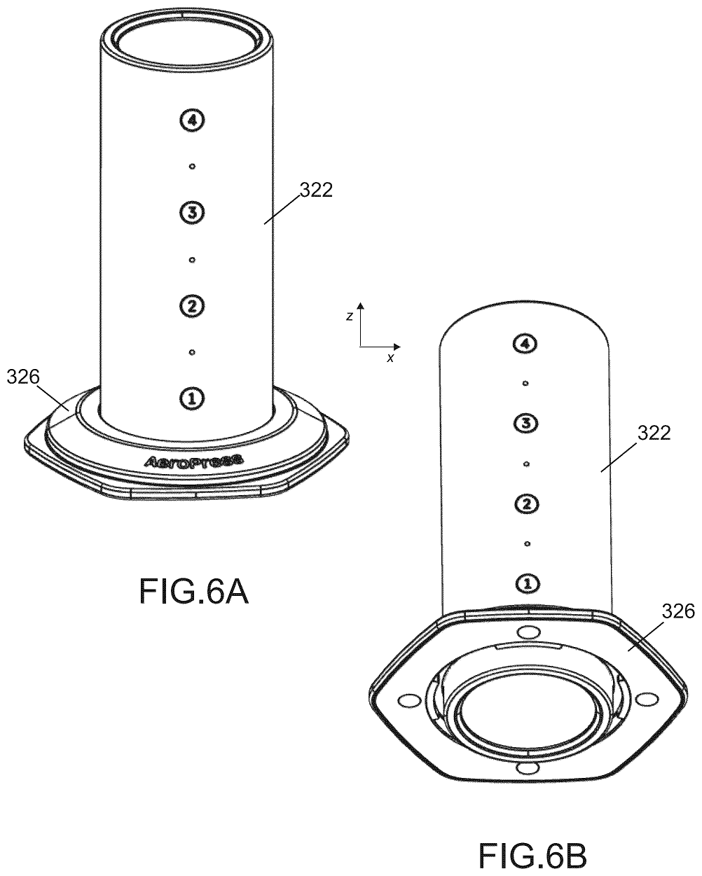

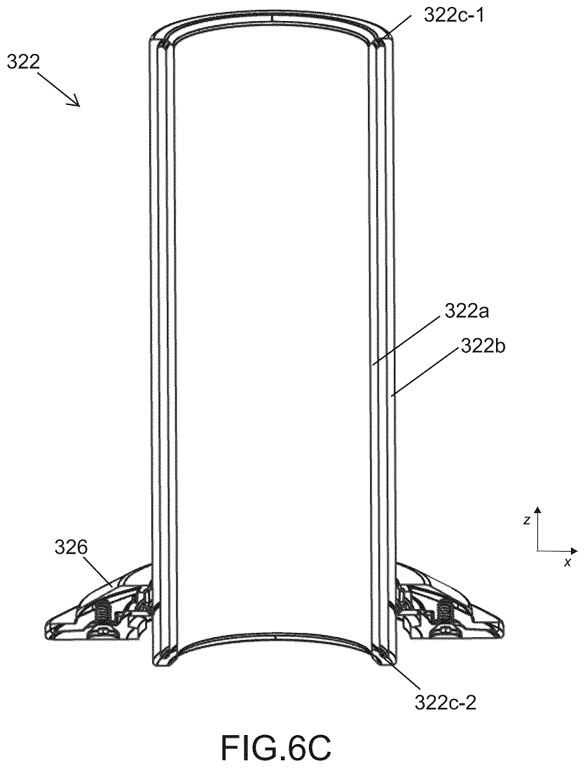

FIGS. 6A-6C show details views of the outer cylinder 322 with metal base 326, in accordance with some embodiments. FIGS. 6A and 6B show upper and lower perspective views of the outer cylinder 322 having a metal base 326 mounted along the bottom portion. As described herein, the metal base 326 extends laterally outward from the bottom portion near the bottom opening and defines a lateral support surface 326d that engages a top surface of a beverage container during pressing. In this embodiment, the base is formed of metal, such as aluminum or stainless steel, although it is appreciated that any suitable material could be used. FIG. 6C shows a sectional view along an x-z mid-plane, illustrating the walls of the double-walled cylinder, which shows that the cylinder is formed of an inner wall 322a of an inner cylinder and an outer wall 322b of an outer cylinder, the cylinder being concentric and sealed along the top and bottom openings with a gap in between, which may be filled with air or an inert gas, or a vacuum may be drawn to enhance the insulative property of the cylinder. In some embodiments, the cylinders are sealed together by a scam 322c-1 at top and by a scam 322c-2 at bottom. The seal seam can be formed of glass or curable polymer, or any suitable material. In some embodiments, the inner cylinder has a diameter of 2.647″ and the outer cylinder has a diameter of about 2.874″ such that the air gap is within a range of about 0.2-0.3″, typically about 0.23″. Such a configuration provides the dimension and tolerances needed for the plunger to maintain an air-tight seal the entire length of the cylinder during pressing at the requisite pressure to produce the beverage by pressing through the filter cap.

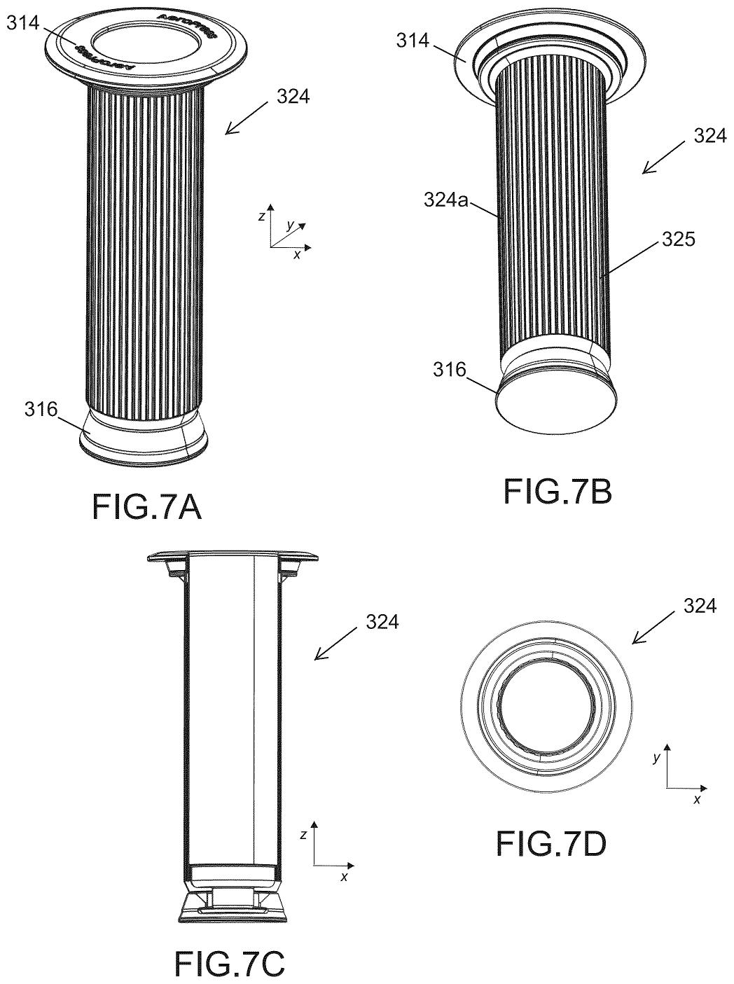

FIGS. 7A-7D show details views of an exemplary piston 324 suited for use with a premium press assembly, in accordance with some embodiments. In this embodiment, the piston is formed primarily of metal, such as aluminum or stainless steel. As in previous embodiments, the piston includes a proximal stop 314 and a distal plunger 316. The proximal stop 316 extends laterally to act as a stop when the piston is pressed through the cylinder and the top surface having a flattened surface to facilitate manual pressing of the piston. The main body 324a of the piston can include fluting or ridges 325 to increase the compressive strength of the piston to withstand forces from pressing. FIG. 7C is a sectional view along the x-z mid-plane. FIG. 6D is a sectional view along an x-y mid-plane, showing ridges 325 along the main piston body 324a.

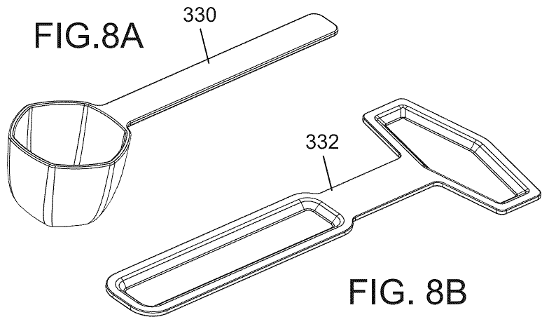

FIG. 8A-8B show accessories for use with a beverage press, in accordance with some embodiment. FIG. 8A shows scoop 330 for use in filling the cylinder with coffee grounds. FIG. 8B shows a stirrer paddle 332 configured for stirring the heated water and coffee grounds during steeping. The stirrer paddle 332 includes a laterally extending portion at a proximal end for holding the stirrer during use and a length-wise stirrer portion for stirring the coffee grounds and heated water in the cylinder. In some embodiments, the length of the stirrer portion to the laterally extending handle portion is less than the height of the cylinder so that the distal end of the stirrer does not contact the filter held in the beverage cap at the distal end of the cylinder.

FIGS. 9A-9B show a coffee or tea filtering press 1 according to embodiment of the invention. It is appreciated that these aspects are exemplary to illustrate how the respective components function during use and that these aspects can pertain to any of the presses described herein. Press 1 includes a hollow cylinder 2 having top and bottom openings. A removable filter cap 3 encloses the bottom opening. The cap can support a removable filter, such as a metal or paper filter therein. A filter 8 may be captured between the cap 3 and the cylinder 2 to strain particles from the liquid. As an alternative, the filter can be integrated into the cap structure. A removable piston 4 is inserted into the top opening and pressed downward to force liquid 5 in the cylinder through the filter cap. While a perforated filter cap with multiple holes is shown, it is appreciated any filter cap could be used (e.g. pressure-activated valve cap). The press has a support 6 to hold it on the mouth of an open vessel 7. FIG. 9A shows stirrer or stirring paddle 9 having upper stop 10 and a length, measured from its distal/lower extremity 11 to stop 10, which is slightly less than the length of cylinder 2. The stop prevents the tip 11 of the paddle from touching the cap 3 or the filter 8 during stirring. This aspect can be utilized in any of the stirrer paddles described herein.

In operation, the press 1 is placed on an open vessel 7. Ground coffee or tea is put into the cylinder 2. Hot water is added and the mixture is stirred with paddle 9. The paddle is then removed and piston 4 is inserted into the top opening and pressed downward to force the liquid 5 through the filter and perforated cap and into the vessel. The piston pressurizes the air 20, above the liquid and it is this pressurized air which forces the liquid 5 through the cap. When the liquid is expelled, the press is then lifted off the vessel and the cap 3 is removed. Finally piston 4 is pressed farther to eject the spent puck 21 of coffee or tea into a waste receptacle. The piston 4 is capped with a flexible seal 12 to engage the inside of the cylinder. The seal preferably has its maximum diameter 13 at its lowest point in order to wipe clean the inside of the cylinder when the maximum diameter is pushed fully through the cylinder with the cap removed during ejection of the spent puck. The piston 4 has a stop 14 which limits the maximum travel of the piston but permits the maximum diameter 13 of the seal to extend beyond the bottom opening of the cylinder with the cap removed to eject the spent puck. The perforated cap 3 has one or more holes on the bottom. In some embodiments, the cap includes a single central opening with a pressure-activated valve. In the embodiment shown, the cap includes multiple holes to allow flow of beverage therethrough. In the embodiment shown, the cap further includes multiple drain holes 15, adjacent to and radially external to a perimeter line defined by the outer circumference of the bottom of cylinder 2. These drain holes relieve pressure between the outer wall of the cylinder and the inner wall of the cap and prevent leakage out of the top edge of the cap.

In FIGS. 9A-9B, perforated cap 3 is attached to cylinder 2 with a twist-lock 16. This twist lock can include four ramped grooves in the support/base that receive correspondingly shaped tabs in the filter cap. This attachment can be used to attach the filter cap in any of the beverage presses described herein. Alternatively, various other attachment means could be used

FIG. 9C illustrates and alternative version of the invention with the support 6A extending radially outward from the perforated cap 3A. This figure also illustrates an alternative attachment method in which the perforated cap is attached to the cylinder with a screw thread 17. Yet another alternative would be to secure the perforated cap to the cylinder with a latch. The alternative cap and support of FIG. 9C also has an upper cavity 19 to collect liquid which leaks between the cylinder 2 and the cap 3A. FIGS. 9A-9C also illustrate a central bottom step 18 which extends below the rim of the open vessel in order to keep the press from slipping off the vessel. In FIGS. 9A-9B, this bottom step is the lower portion of cap 3. In FIG. 9C, bottom step 18 is an extension below the lower surface of cap 3A. This central bottom step may or may not contact the inner walls of the vessel depending on the size of the opening of the vessel. Supports 6 and 6A are shaped to permit air to pass readily out of the open vessel when the press is resting on top of the vessel and liquid is entering the vessel. The twist lock 16 of FIG. 9A and FIG. 9B has through-holes 22 which achieve this. In the alternative embodiment of FIG. 7, the bottom surface of support 6A is roughened or grooved to achieve this same result.

While the cylinder may be made from a wide range of materials, the preferred materials are transparent so that the user can observe the pressing process. Glass and transparent plastics are suitable. The piston can also be made transparent, clear or opaque (e.g. metal). In some embodiments, both the cylinder and the piston body are made from clear plastic so that a user can see the process of the coffee grounds steeping in the heated water and being pressed. In some embodiments, the clear plastic is a copolymer made from three monomers: dimethyl terephthalate (DMT), cyclohexanedimethanol (CHDM), and 2,2,4,4-tetramethyl-1,3-cyclobutanediol (CBDO). Preferably, the clear plastic is additionally BPA free. It is appreciated the cylinder and piston body (except the elastomeric plunger) can be made entirely of the clear plastic. In some embodiments, only part of the cylinder and/or piston may be made from clear plastic. In some embodiments, the cylinder main body is made from clear plastic and the support base may be formed of another type of plastic or metal.

It is appreciated that a wide range of dimensions are feasible for the invention. In some embodiments, a cylinder having an inside diameter of approximately 2.25 inches and a length of approximately 5 inches has been found to perform very well for pressing a quantity of beverage suitable for a single serving of beverage (e.g. 250 ml capacity), for example, to dispense an amount suitable for a standard cup of coffee or tea. In some embodiments, such as that of FIGS. 1A-1D a cylinder having a larger diameter and height is used for dispensing a larger quantity of beverage, such as twice the capacity (e.g. 500 ml, 600 ml or more), as discussed previously.

In yet another aspect, the invention pertains to a beverage press organizer stand, which supports and organizes the beverage press components, such as any of those described herein, as well as various accessories, which can include the stirrer paddle, scoop and filter(s), such as those shown in FIGS. 8A-8B. In some embodiments, the beverage press organizer stand can be adjustable in height so that the beverage press supports both standard and oversized beverage press models. In another aspect, the beverage press holder includes frame having an enclosed perimeter that defined an opening shaped to support the piston and cylinder side-by-side. In some embodiments, the opening of the holder frame is dimensioned to support both standard beverage press and oversized beverage presses. In any of the embodiments, the stand can be formed of multiple components coupled together, or some or all can be integrally formed.

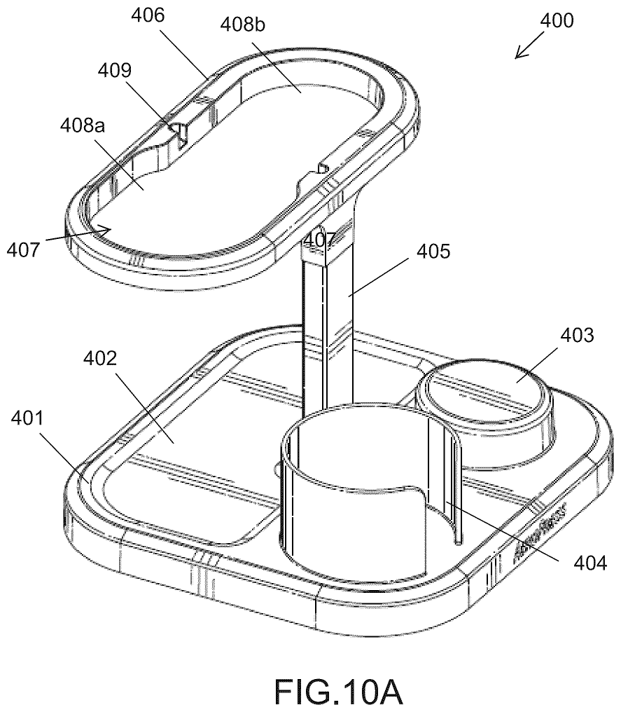

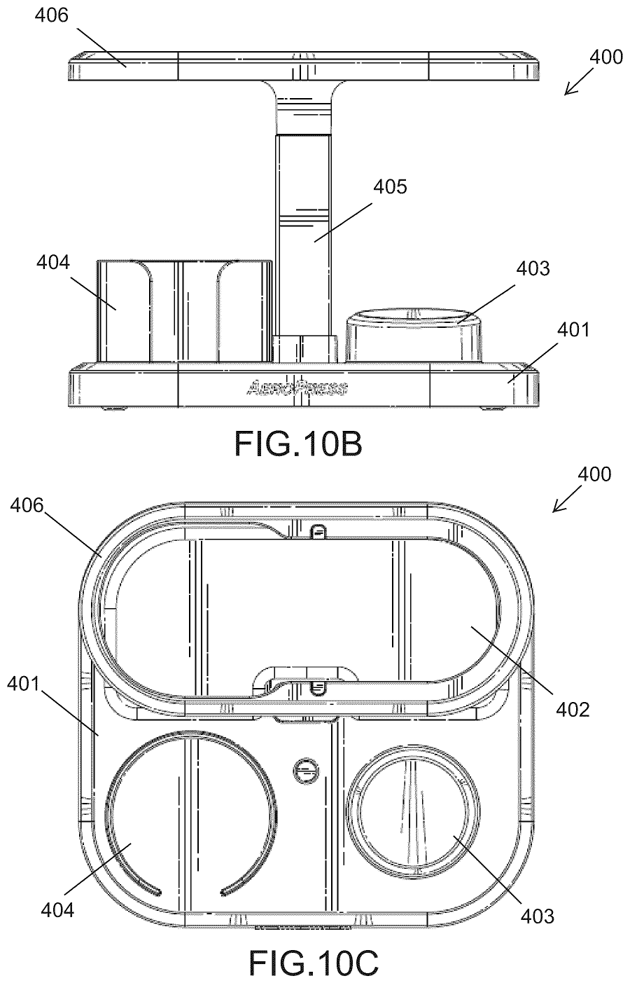

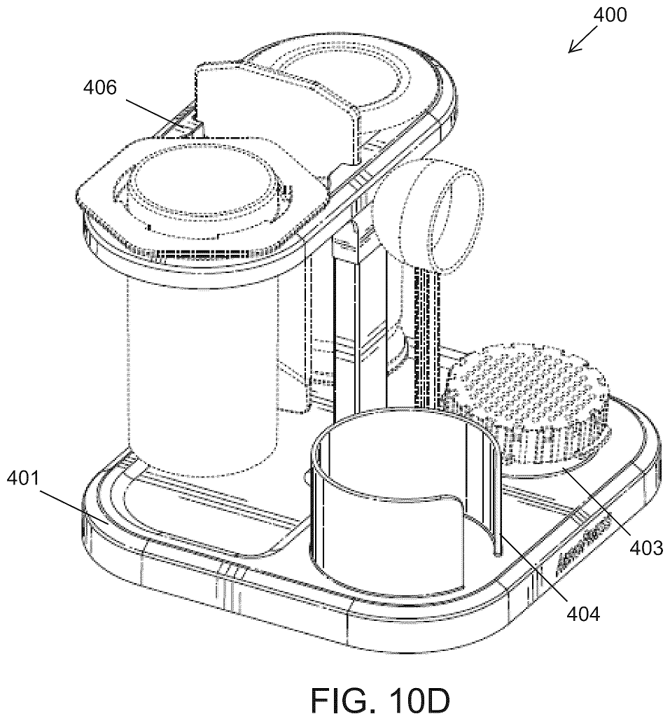

FIGS. 10A-13B shows exemplary beverage press organizer stands configured for holding the components of the beverage press before and after use. In these embodiments, the organizer stand includes a single ring that holds the cylinder and pistons side-by-side and one or more vertical supports that suspend the ring holder. In some embodiments, the ring includes a single opening for the cylinder and piston and a separate opening for accessories, such as the scoop and stirrer paddle. The stands can be formed of plastic, metal, or combination of materials.

FIGS. 10A-10C show organizer stand holder 400 includes a base 401 and a vertical support 405 that extends to a holder frame 406 defining an enclosed single opening 407, which is shaped to include specially sized regions 408a, 408b that receive the cylinder and piston in a side-by-side configuration. The opening can further include notches 409 near the middle that are dimensioned to receive a top of the stirrer between the cylinder and piston. The base can include a drainage recess or depression 402 for capturing any liquid droplets from the cylinder and piston after rinsing/washing and placement in the holder, a filter holder 404 for holding a stack of paper filters and a beverage cap holder 403 (e.g. circular protrusion) for holding the filter cap thereon and a hole for supporting the proximal handle of the coffee scooper. FIG. 10D shows the holder 400 with the above-noted components supported thereon.

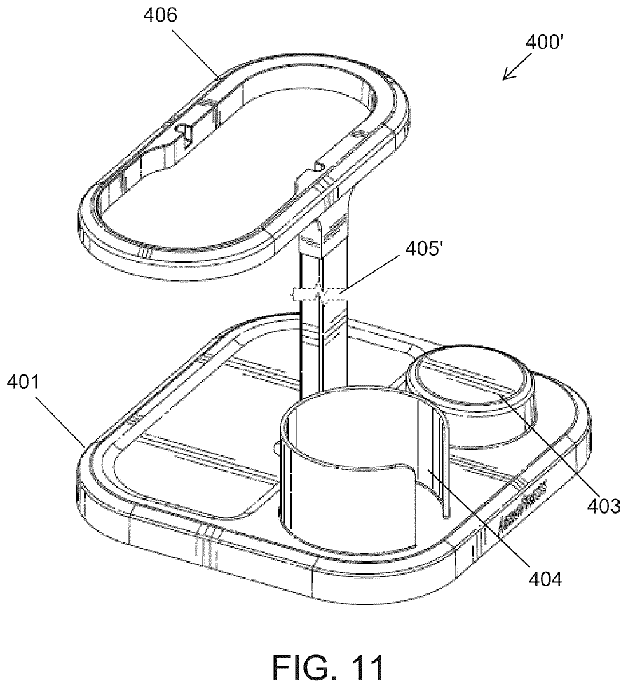

FIG. 11 shows another organizer stand holder 400′ having same or similar components as that of FIG. 10A, except vertical support 405′ has an adjustable length, which can be achieved by a replaceable/removable of the vertical support or by an adjuster or any suitable means.

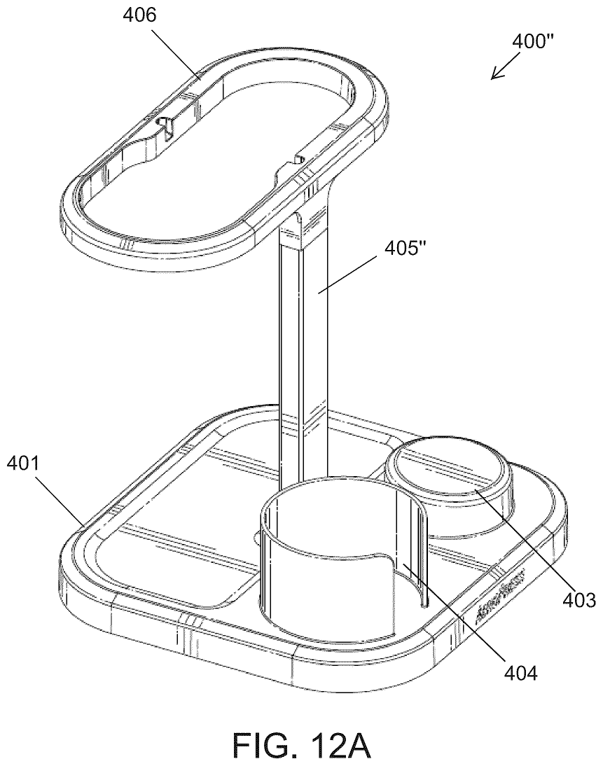

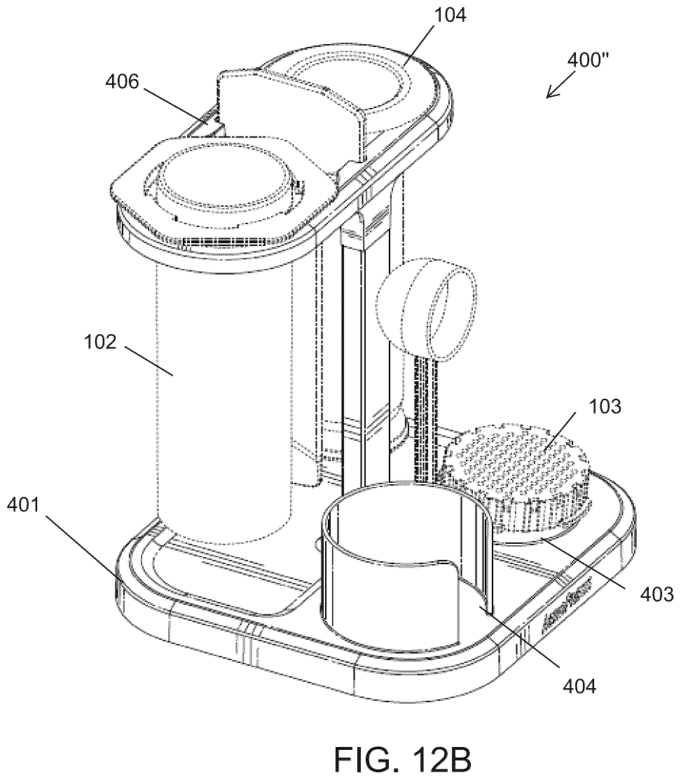

FIGS. 12A-12B show another organizer stand holder 400″ having same or similar components as the embodiment in FIG. 10A, except the holder has been configured to support an oversized press assembly, as shown in FIG. 10B. Holder 400″ can be provided in a set configuration dimensioned for the oversized press assembly or can be adjusted by replacing the vertical support of the holder in FIG. 10A with a vertical support 405″ that is longer in length. In some embodiments, the holder is provided with two vertical supports of differing length so that a user can adjust the holder to fit either a standard beverage press or an oversized beverage press, such as that in FIG. 1A.

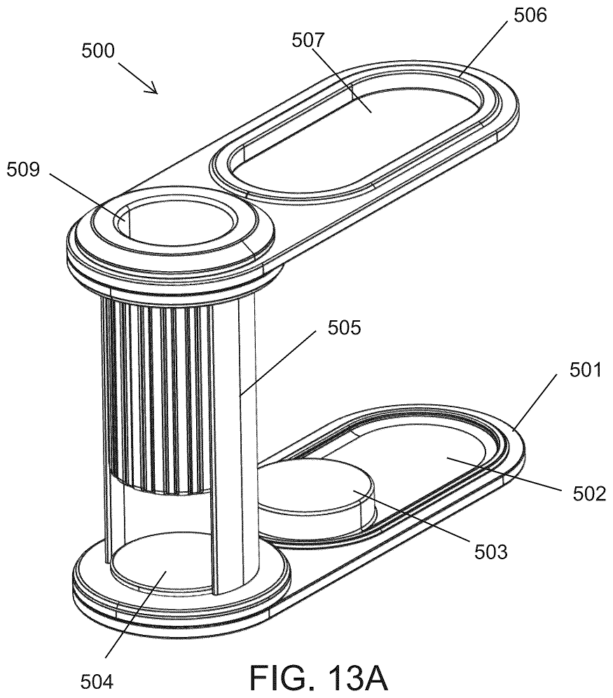

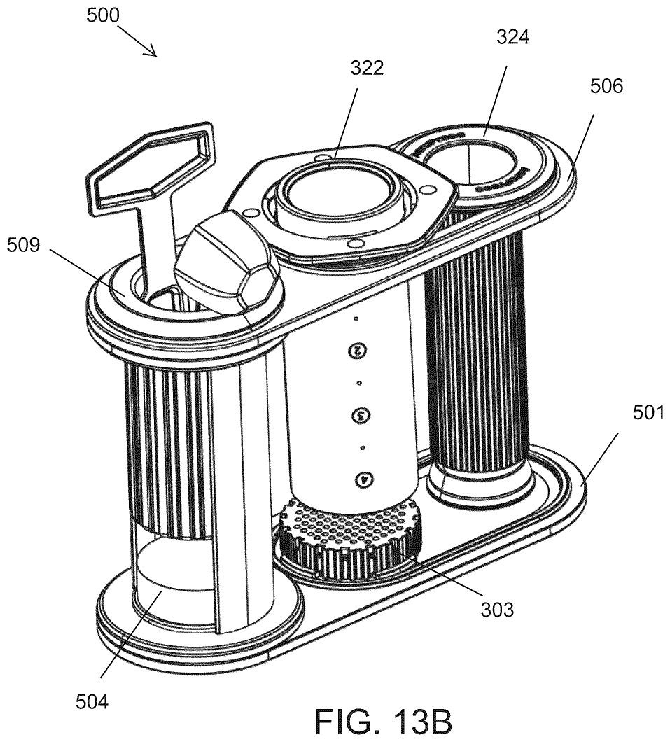

FIGS. 13A-13B show another organizer stand holder 500 having similar components as the embodiment in FIG. 10A. Organizer stand holder 500 includes a base 501 from which extends a vertical support 505 to a holder frame 506. In this embodiment, the frame 506 includes a single opening 507 that is configured to hold the cylinder and piston side-by-side, and includes another opening supporting a holder cup 509 for accessories (e.g. stirrer paddle and scoop). In this embodiment the single opening is oblong or pill-shaped. In this embodiment, the base includes a drainage depression 502 for catching any droplets from the cylinder and piston after rinsing, a beverage cap holder 503 and a filter paper holder 504. In this embodiment, the vertical support also houses the holder cup 509 and partly encloses the filter paper holder 504, which helps shield the stack of filter papers from droplets or splashing when the cylinder and piston are placed in the holder after rinsing. In this embodiment, the organizer stand is formed of metal, such as aluminum or stainless steel or metal alloy, to match the aesthetic and durability of the premium press in FIG. 5A. FIG. 13B shows the components of the premium press assembly of FIG. 5A supported in the premium organizer stand of FIG. 13A. In this embodiment, the holder cup 509 is configured with ridges similar to the piston so that the assembly has a more symmetrical appearance, as shown in FIG. 13B.

While the above is a complete description of specific embodiments of the invention, the above description should not be taken as limiting the scope of the invention as defined by the claims. While particular dimensions and shapes are shown and described in regard to the beverage press components and carafe, it is appreciated that various other dimensions may be utilized as well. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive.

What is claimed is:

1. A beverage making system comprising:
a beverage filter press including:
a hollow cylinder having a first opening at a first end and a bottom opening at a second end, wherein a support extends laterally outward from an exterior of the hollow cylinder at the first end, and dimensions of the hollow cylinder correspond to a volume of liquid equivalent to at least twice that of a single beverage serving, wherein a perimeter of the support forms a polygon,
a removable piston configured to be inserted into the cylinder and create an airtight seal when coupled with the hollow cylinder; and
a removable filter cap couplable to the cylinder or support so as to enclose the bottom opening.

2. The system of claim 1, wherein the cylinder has a height range between 5-8 inches.

3. The system of claim 2 wherein the cylinder has a diameter between 2-4 inches.

4. The system of claim 1, further comprising:
a vessel having a polygonal cross-sectional shape corresponding to that of the support of the hollow cylinder, wherein the vessel has an opening at a top side and a top edge that extends around the opening, wherein the carafe is sized so that the support of the hollow cylinder substantially extends beyond the top edge of the vessel to firmly engage the support during pressing.

5. The system of claim 4, wherein the polygonal shape of the support and the vessel comprises a hexagon.

6. The system of claim 4, wherein the vessel top opening is configured to loosely fit with the filter press.

7. The system of claim 4, wherein the polygonal cross-section of the vessel comprises a plurality of vertexes, wherein each vertex where vertical planes of an outside of the vessel meet is rounded.

8. The system of claim 7, wherein the vessel has at a depression on at least one vertex along the top edge so as to define a spout by which filtered beverage is poured from the carafe.

9. The system of claim 4, wherein the vessel has a height range between 4-6 inches.

10. The system of claim 9, wherein the vessel has a greatest lateral dimension between 3-5 inches.

11. A beverage making system comprising:
a beverage filter press including:
a hollow cylinder having a first opening at a top opening and a bottom opening, wherein the hollow cylinder is formed of glass;
a support base that extends laterally outward from an exterior of the hollow cylinder at the first end;
a removable piston configured to be inserted into the cylinder and create an airtight seal when coupled with the hollow cylinder; wherein a main body of the piston is formed of metal; and
a removable filter cap couplable to the cylinder or support so as to enclose the bottom opening of the hollow cylinder.

12. The system of claim 11, wherein the hollow cylinder is double-walled and vacuum insulated.

13. The system of claim 11, wherein the double-walled cylinder comprises concentric glass cylinder that are sealed along the top and bottom openings.

14. The system of claim 13, wherein the support base is formed of a metal and securely mounted to the hollow cylinder.

15. The system of claim 13, further comprising:
a plastic ring attached to an outside of the hollow cylinder near the bottom opening by a curable adhesive, wherein the plastic ring is engaged between upper and lower mounts of the support base, thereby securing the support base to the hollow cylinder.

16. The system of claim 15, wherein the upper and lower mounts comprise metal rings that are drawn together by one or more fasteners.

17. The system of claim 16, wherein the one or more fasteners comprise a plurality of screws distributed around a circumference of the cylinder.

18. The system of claim 11, wherein the piston main body has is fluted or ridged.

19. The system of claim 11, wherein the metal is aluminum or stainless steel.

20. A beverage press organizer stand comprising:
a base;
a vertical support extending between a bottom end and a top end, the vertical support being coupled to the base at a bottom end thereof; and
a holder frame extending horizontally and coupled to the top end of the vertical support, wherein the holder frame is attached to a top portion of the vertical support, and has a first opening sized to accommodate a cylinder and a piston of a beverage press side-by-side.

21. The organizer stand of claim 20, wherein the vertical support is the one and only support for the holder frame.

22. The organizer stand of claim 20, wherein a height of the holder frame is adjustable by a user to accommodate different sized filter presses.

23. The organizer stand of claim 20, wherein a height of the holder frame is adjustable by replacing the vertical support with another vertical support of differing height.

24. The organizer stand of claim 20, wherein the holder is provided with at least two vertical supports of differing length, one vertical support defining a height of the organizer frame suitable for a standard sized beverage press and another vertical support defining the height of the organizer frame for an oversize beverage press.

25. The organizer stand of claim 20, wherein the base includes a paper filter holder, a beverage cap holder, and a drainage recess.

26. The organizer stand of claim 20, wherein the first opening is an oblong or pill shape dimensioned to support the cylinder and piston at opposite ends.

27. The organizer stand of claim 26, wherein the frame includes a second opening that supports a holder cup for one or more accessories.

28. The organizer stand of claim 27, wherein the base includes a paper filter holder, a beverage cap holder, and a drainage recess.

29. The organizer stand of claim 28, wherein the vertical support houses the holder cup and partly encloses the paper filter holder.

30. The organizer stand of claim 20, wherein the base, vertical support and frame are formed of a metal.
